(19) United States
(12) Patent Application Publication
(10) Pub. No.: US 2004/0179910 A1
(43) Pub. Date: Sep. 16, 2004

(54) Drill press

(75) Inventors: John L. Theising, St. Peters, MO (US); Randall W. Robison, O'Fallon, MO (US)

Correspondence Address: HOME DEPOT USA, INC., 2455 PACES FERRY RD. NW, STORE SUPPORT CENTER, C-19, ATLANTA, GA, 30339, US

(73) Assignee: EMERSON ELECTRIC CO., St. Louis, MO (US)

(21) Appl. No.: 10/249,057

(22) Filed: Mar. 12, 2003

(51) Int. Cl. B23B 47/18

(52) U.S. Cl. 408/135

(57) ABSTRACT

In one aspect of the present invention, a drill press includes a feed assembly that can be switched from one side of the drill press to the other, allowing either right-hand or left-hand opeation. The drill press includes a drill housing with a generally vertically extending spindle rotatably mounted in the housing. A motor is operably connected to the spindle to drive the spindle, and a shaft extends through the drill housing generally transversely to the spindle. A hub assembly is interchangeably connected to one of the ends of the shaft, and a spring housing is interchangeably connected to the other end of the shaft. The spring housing has a first side that is situated adjacent the drill housing if the spring housing is received by one end of the shaft, and a second side that is situated adjacent the drill housing if the spring housing is received by the other end of the shaft. A torsion spring is contained within the spring housing.

### BACKGROUND OF THE INVENTION

1. Field of the Invention

The present invention relates generally to drill presses, and more particularly, to a drill press feed capable of either right-handed or left-handed operation.

2. Description of Related Art

Drill presses are well known. A drill press (or overhead router) generally includes an upright column supported by a heavy base. A work-support table is supported by the column and may be moved up and down and clamped at a desired height. A drill head or housing is mounted on top of the column and supports a motor and spindle above the table. A drill chuck at the lower end of the spindle holds a selected drill in position for drilling. By replacing the drill chuck with a collet, a routing tool can be mounted for routing purposes.

A feed mechanism allows up and down positioning of the spindle relative to the table. Typically, an operator turns a feed handle to selectively adjust the height of the spindle. The operator can lower the spindle towards the work piece supported by the table for the drilling or cutting operation, and a spring mechanism returns the spindle to it's original position. Known drill presses have feed handles mounted on the right side of the unit, essentially designed for right-handed people. This tends to be inconvenient for left handed people.

The present application addresses these shortcomings associated with the prior art.

### SUMMARY OF INVENTION

In one aspect of the present invention, a drill press includes a feed assembly that can be switched from one side of the drill press to the other, allowing either right-hand or left-hand opeation. The drill press includes a drill housing with a generally vertically extending spindle rotatably mounted in the housing. A motor is operably connected to the spindle to drive the spindle, and a shaft extends through the drill housing generally transversely to the spindle. A hub assembly is interchangeably connected to one of the ends of the shaft, and a spring housing is interchangeably connected to the other end of the shaft. The spring housing has a first side that is situated adjacent the drill housing if the spring housing is received by one end of the shaft, and a second side that is situated adjacent the drill housing if the spring housing is received by the other end of the shaft. A torsion spring is contained within the spring housing. A scale is attached to the hub assembly, and can be re-oriented as necessary depending on whether the hub assembly is received by the first or second end of the shaft.

### BRIEF DESCRIPTION OF DRAWINGS

Other objects and advantages of the invention will become apparent upon reading the following detailed description and upon reference to the drawings in which:

FIG. 1 is a front and left perspective view of a drill press in accordance with an exemplary embodiment of the present invention.

FIG. 2 is a front and right perspective view of a portion of the drill press shown in FIG. 1.

FIG. 3 is a front and left perspective view, partially exploded, showing the hub assembly on the right side of the drill press.

FIG. 4 is a front and right perspective view, partially exploded, showing the hub assembly on the left side of the drill press.

FIG. 5 is an exploded view of a spring assembly in accordance with an exemplary embodiment of the present invention.

FIGS. 6A and 6B are perspective views of a drill press housing in accordance with aspects of the present invention.

FIG. 7 is a close-up view of a hub assembly in accordance with aspects of the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION

Illustrative embodiments of the invention are described below. In the interest of clarity, not all features of an actual implementation are described in this specification. It will of course be appreciated that in the development of any such actual embodiment, numerous implementation-specific decisions must be made to achieve the developers” specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

Referring to the Figures, a drill press in accordance with exemplary embodiments of the present invention is shown. A drill press and an overhead router have the same general configuration. With a drill press, a drill chuck holds a selected drill in position for drilling. By replacing the drill chuck with a collet, a routing tool can be mounted for routing purposes. The phrase “drill press” as used in this disclosure is intended to include drill presses, overhead routers and other similar tools.

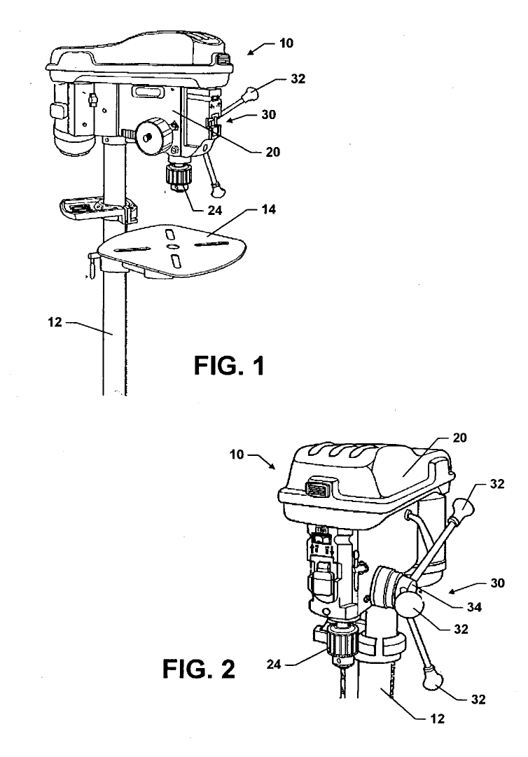

Referring to FIGS. 1 and 2, the drill press 1 0 includes a frame having a vertically extending column 12 that supports a horizontal work table 14. At the upper end of the column 12, a housing 20 encloses a motor that rotatably drives a generally vertically extending spindle 22 that receives a chuck 24. A feed assembly 30 axially moves the spindle 22 up and down relative to the work table 14 as desired by a user. The feed assembly 30 includes feed handles 32 extending from a hub 34.

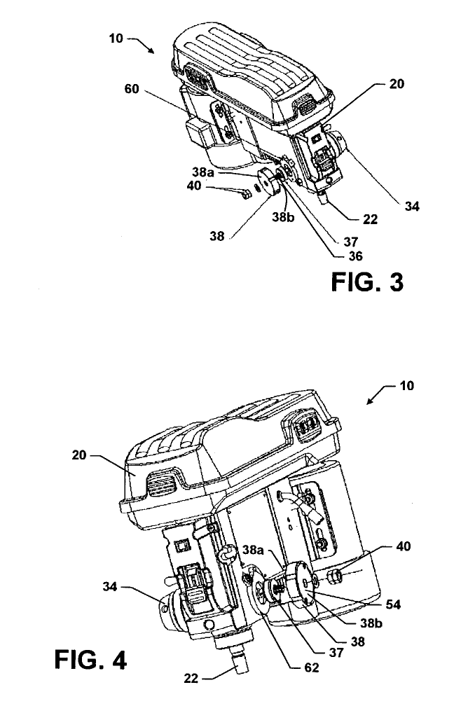

FIGS. 3 and 4 show perspective views of the drill press housing 20. In FIGS. 3 and 4, the hub 34 is shown without the handles 32 for simplicity. A driver shaft 36 extends through the housing 20, oriented generally transversely to the spindle. The hub 34 is connected to one end of the driver shaft 36, with the other end of the driver shaft 36 receiving a bushing 37 and a spring assembly 38, which are secured to the shaft 36 by one or more nuts 40. The driver shaft 36 is connected to the spindle so as to move the spindle axially—up and down—in response to rotation of the shaft 36. Typically, the shaft 36 turns a driver pinion (not shown) that engages a rack (not shown) to move the spindle 22 up and down as desired by a user. The rack and pinion arrangement is well known and an example of such an arrangement is shown in U.S. Pat. No. 5,517,746, which is incorporated by reference. The spring assembly 38 includes a spring that functions to return the hub 34 and feed handles 32 to their original position after feeding.

As noted herein above, with known drill presses, the feed handles 32 of the feed assembly 30 are situated permanently on the right side of the drill press 10, which is convenient for right-handed users. In accordance with aspects of the present invention, the hub 34 and spring assembly 38 of the feed assembly 30 are removable, allowing them to be reversed such that the hub 34 and feed handles 32 can to be mounted on either side of the drill press 10. This allows right-handed people the option of mounting the feed handles 32 on the right side (FIG. 3), and left-handed people the option of mounting the feed handles 32 on the left side (FIG. 4) of the housing 20.

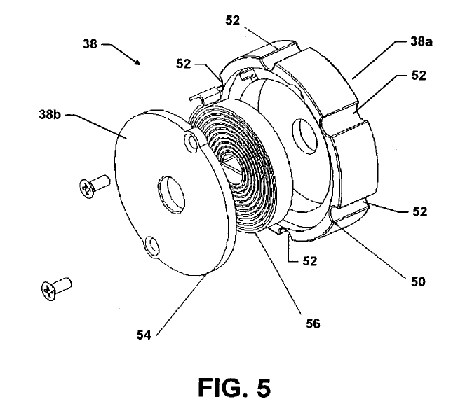

FIG. 5 is an exploded view of an exemplary embodiment of the spring assembly 38. The spring assembly 38 includes a spring housing 50 that is generally symmetrical, allowing it be mounted to either side of the housing 20 for right or left-handed use of the drill press 10. The illustrated spring housing 50 defines a plurality of keyways 52 generally situated about the periphery of the spring housing 50. A torsion spring 56 is received in the spring housing 50, and a cover 54 mates with the spring housing 50 to contain the spring 56. The spring housing 50 is large enough in size to allow safe and easy winding of the spring assembly 38 by hand to adjust the tension of the spring 52, facilitating the transfer of the feed assembly 30 from one side of the drill press 10 to the other.

The spring assembly 38 has two opposing sides 38a and 38b. Referring to FIGS. 3 and 4, when the spring assembly is received by the shaft 36 such that the spring assembly 38 is situated on the left side of the drill press housing 20 (as viewed in FIG. 3), side 38b (the cover 54) is adjacent the drill press housing 20. When the spring assembly 38 is on the opposite side of the drill press housing 20 (the right side as viewed in FIG. 4), side 38a is adjacent the drill press housing 20 with side 38b (the cover 54) facing away from the housing 20. Accordingly, the spring assembly 38 is wound clockwise to increase the spring tension when the spring assembly 38 mounted on the right side of the drill press 10 and counterclockwise when mounted on the left side. The particular spring housing 50 illustrated has six keyways 52, any one of which can engage a cap screw 60 mounted in the drill press housing 20 (shown in FIG. 3) to maintain the appropriate spring tension to return the feed handles 32 to their original position. The spring housing 50 completely encloses the torsion spring 52 to prevent any sharp edges of the spring 52 from contacting a user in the event that the housing 50 slips during winding.

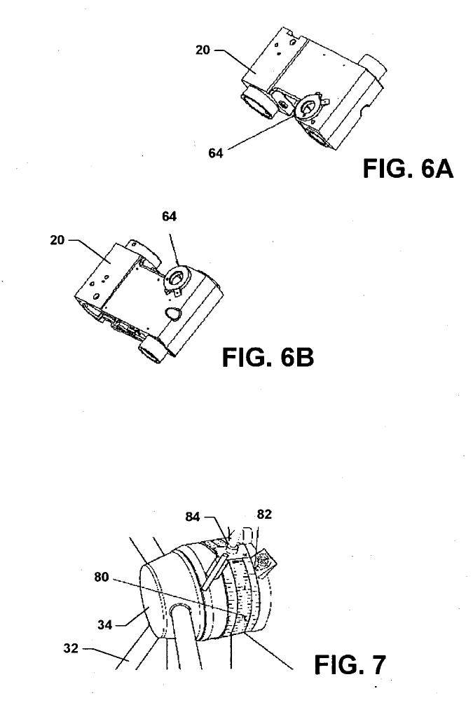

FIGS. 6A and 6B show opposite sides of the drill press housing 20. Symmetrical features 64 are molded or machined into the drill press housing 20. These features 64 allow both ends of the shaft 36 to receive either the hub assembly 34 or the spring assembly 38, such that the feed handles 32 can be mounted on either side of the housing 20.

FIG. 7 shows the hub 34, including a depth scale. The depth scale can be removed and rotated so that it is legible regardless of which side of the drill press housing 20 the hub assembly 34 is mounted on. The depth scale includes a scale 80 and a depth indicator 82. The scale 80 and the indicator 82 are removable so that they can be repositioned when the hub assembly 34 is moved from one side of the drill press housing 20 to the other. A screw 84 fastens the scale 80 in place.

Illustrative embodiments of the invention are described below. In the interest of clarity, not all features of an actual implementation are described in this specification. It will of course be appreciated that in the development of any such actual embodiment, numerous implementation-specific decisions must be made to achieve the developers” specific goals, such as compliance with system-related and business-related constraints, which will vary from one implementation to another. Moreover, it will be appreciated that such a development effort might be complex and time-consuming, but would nonetheless be a routine undertaking for those of ordinary skill in the art having the benefit of this disclosure.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

1. A drill press, comprising:
a drill housing;
a generally vertically extending spindle rotatably mounted in the housing;
a motor operably connected to the spindle to drive the spindle;
a shaft extending through the drill housing generally transversely to the spindle, the shaft having first and second ends;
a hub assembly interchangeably connected to one of the first or second ends of the shaft;
a spring housing interchangeably connected to the other of the first or second ends of the shaft, the spring housing having a first side situated adjacent the drill housing if the spring housing is received by the first end of the shaft, and a second side situated adjacent the drill housing if the spring housing is received by the second end of the shaft; and
a torsion spring contained within the spring housing.

2. The drill press of claim 1, wherein the torsion spring is wound in a first direction when the first end of the shaft receives the spring housing and the torsion spring is wound in a second direction when the second end of the shaft receives the spring housing.

3. The drill press of claim 1, wherein the spring housing defines a plurality of keyways situated about the periphery thereof.

4. The drill press of claim 3, wherein a selected one of the keyways interacts with a screw received by the drill housing to fix the spring housing relative to the drill housing.

5. The drill press of claim 1, further comprising a scale situated about the hub assembly, the scale being in a first orientation when the first end of the shaft receives the hub assembly and in a second orientation when the second end of the shaft receives the hub assembly.

6. A method of axially moving a drill press spindle, comprising:
attaching a hub assembly having a handle to a first end of a shaft extending through a housing of the drill press, the shaft operably connected to the spindle to axially move the spindle in response to rotation of the shaft;
attaching a spring housing to a second end of the shaft, such that a first side of the spring housing is situated adjacent the housing of the drill press;
rotating the spring housing in a first direction to tension a spring contained in the spring housing;
fixing the spring housing relative to the housing of the drill press;
moving the handle to rotate the shaft;
removing the hub assembly and the spring assembly from the shaft;
attaching the hub assembly to the second end of the shaft;
attaching the spring housing to the first end of the shaft, such that a second side of the spring housing is situated adjacent the housing of the drill press;
rotating the spring housing in a second direction to tension the spring;
fixing the spring housing relative to the housing of the drill press; and
moving the handle to rotate the shaft.

7. The method of claim 6, wherein fixing the spring housing includes receiving a screw extending from the housing of the drill press in one of a plurality of keyways situated about the periphery of the spring housing.

8. The method of claim 6, further comprising attaching a scale to the hub in a first orientation when the hub is attached to the first end of the shaft.

9. The method of claim 6, further comprising attaching a scale to the hub in a second orientation when the hub is attached to the second end of the shaft.
